(19) United States
(12) Patent Application Publication
(10) Pub. No.: US 2007/0128013 A1
(43) Pub. Date: Jun. 7, 2007

(54) Apparatus protecting vehicle with bucket when bucket strikes fixed object

(76) Inventor: Grant Hanson, Glenwood, MN (US)

Correspondence Address: HAMRE, SCHUMANN, MUELLER & LARSON, P.C., P.O. BOX 2902, MINNEAPOLIS, MN, 55402-0902, US

(21) Appl. No.: 11/291,259

(22) Filed: Dec. 1, 2005

(51) Int. Cl. B66C 23/00

(52) U.S. Cl. 414/699; 172/2

(57) ABSTRACT

A mounting apparatus for a bucket of a front end loader vehicle. The mounting system allows the bucket to pivot up and over fixed objects when the leading edge of the bucket strikes an immovable object for the purpose of protecting the loader assembly, vehicle, and operator.

### FIELD OF THE INVENTION

The disclosed invention is directed generally to front end loader vehicles with a bucket, particularly a bucket apparatus for snow clearing and more particularly apparatus for protecting the vehicle, loader framework, and driver when the bucket strikes an immovable object when the bucket is sliding along the ground.

### BACKGROUND

Both commercial snow plows and front end loaders have a long history of use in removing snow from streets and highways. Over the past several decades the use of snow plows on light and medium duty trucks has become commonplace. Snow plows work well for clearing snow from roadways, particularly in open places and in areas where yearly snowfall totals are such that the snow can be readily pushed off the roadway. However, in densely populated urban areas, where real estate is at a premium, and in areas with large annual snowfalls, there is a need to be able to lift snow over snowbanks for deposit into large piles. Alternately, the snow is often lifted into dump trucks to be hauled and deposited elsewhere, or dumped into snow melting machines. To address this need, front end loader attachments have been developed. One of the issues related to the use of these loaders is that a great deal of stress is imparted to the structural components when plowing in areas such as those prone to frost heaving where manhole covers, and other relatively fixed objects, are struck by the moving plow. Not only do such encounters with immovable objects greatly shorten the life of the loaders, but they are also quite jarring to the vehicle driver and pose an enhanced risk of injury to the driver as well as others in the vicinity of the loader.

Several devices have been developed for use with snow plows whereby either the whole plow blade, or just a portion of it, pivots back up to about 90 degrees upon encountering a fixed object in the road (see for example U.S. Pat. Nos. 6,701,646 and 5,697,172, respectively). Such devices, while effective for snow plow blades, are not compatible with a loader bucket due to the bucket's different geometry. In particular, the rigid bucket's longitudinal depth combined with the required rear pivotal connections for lifting and dumping, prevent such a pivoting back since such pivoting generally requires a pivot point on an angle greater than 45 degrees up from the leading edge. Furthermore, since such buckets typically have a leading edge attached to the horizontal structure of the bucket bottom, as opposed to a sufficiently vertical structure as is the case with snow plow blades, the obvious tilting back solutions applied to snow plow blades are impractical because this would require tilting the whole bucket backwards by around 180 degrees. Consequently, there is a need for a device which allows loader buckets to ride up over fixed objects upon impacting them, which thereby reduces the wear and tear on front end loader vehicles while also enhancing the safety of the vehicle operator and the public at large.

### BRIEF SUMMARY

The disclosed invention is directed to front end loader apparatus for attachment to a vehicle. In this context, “vehicle” includes a structure comprising a body, wheels, and a means for self propulsion. An example of the type of vehicles to which the invention may be attached includes all-terrain vehicles (ATVs), farm tractors, skid loaders, automobiles, and trucks. The front end loader apparatus has a frame assembly attachable at one end to a vehicle at a first pivot axis and at another end to a bucket. There is a second pivot axis at the attachment of the bucket to the frame assembly. In one embodiment, the present invention has a sensor and control mechanism for determining when the distance between the first and second pivot axes contracts thereby signaling that the bucket has met an immovable object. When a threshold level is reached, a control mechanism causes the bucket to pivot at the second pivot axis, tilt up, and slide over the immovable object. The bucket and framework are thereby spared from bending and breaking, and the vehicle operator is less likely to be injured.

In another set of embodiments, the frame assembly has a pair of downwardly projecting legs which at an end attach to the bucket at the second pivot axis. A member, preferably in the form of a hydraulic cylinder attaches between the frame assembly and the bucket at a location forwardly of the downwardly projecting legs. The hydraulic cylinder is pivotally attached to the bucket to form a third pivot axis. There are hinged joints in each of the projecting legs, and a biasing mechanism in the form of a spring or elastomeric member, or a hydraulic or pneumatic cylinder, or a flexible fluid-filled container which provide a biasing force which maintains the bucket edge along the ground. When the bucket strikes an immovable object and generates a force sufficient to overcome the biasing force, the hinged joints allow the bucket to pivot at the second and third pivot axes so that the bucket can tilt and ride over the immovable object. Once past the object, the biasing mechanism causes the hinged joint to close so that the bucket pivots back to its original scraping position.

In further embodiments, the biasing force provided by the biasing mechanism may be adjusted directly through various mechanical, hydraulic, or pneumatic means of control so that the impact-force threshold beyond which tilting of the bucket occurs may be set by the vehicle operator. For instance, the vehicle driver may set the biasing force at one setting for plowing dirt roads, and at another level when plowing city streets having protruding manhole covers. Any bending and breakage of either the bucket or the framework are avoided, and the vehicle operator is less likely to be injured.

Additionally, an adjustable threshold impact level may be set through the use of sensors incorporated into an electromechanical control circuit, or mechanically through the use of shear pins or a mechanical nipple and détente assembly. For example, when a bucket strikes an immovable object with a force sufficient to cause a nipple and détente assembly to disengage, the hinged joints allow the bucket to pivot at the second and third pivot axes so that the bucket can tilt and ride over the immovable object. The biasing mechanism then causes the hinged joint to close and the nipple and détente assembly to reset, so that the bucket pivots back to its original scrapping position. Again, any bending and breakage of either the bucket or the framework are avoided, and the vehicle operator is less likely to be injured.

### BRIEF DESCRIPTION OF THE DRAWINGS

FIGS. 1A and 1B illustrate schematically in side view a first embodiment of the present invention, including a sensor and bucket tilt control system. FIG. 1A shows the bucket riding over a flat surface; FIG. 1B shows the bucket riding up over a fixed object which it initially struck.

FIG. 2 is a side view of a second embodiment of the present invention.

FIG. 3 is an enlarged plan view of the lower bucket assembly as shown in FIG. 2 taken along auxiliary line 3-3.

FIG. 4A is a sectional view of the lower bucket assembly of the second embodiment as shown in FIG. 3, taken along section line 4-4, showing the assembly in the undeflected position.

FIG. 4B is a sectional view of the lower bucket assembly of the second embodiment as shown in FIG. 3, taken along section line 4-4, showing the assembly in the deflected position as the bucket rides up over a fixed object.

FIG. 5A is a side view of the lower bucket assembly of a further embodiment, which includes a nipple and détente mechanism, showing the assembly in the undeflected position.

FIG. 5B is a side view of the lower bucket assembly of a further embodiment, which includes a nipple and détente mechanism, showing the assembly in the deflected position.

FIG. 6 is a sectional view of the lower bucket assembly of a third embodiment as shown generally in FIG. 3, taken along section line 4-4, showing the assembly in the undeflected position.

FIG. 7 is a side view of the lower bucket assembly of a fourth embodiment of the present invention, showing the assembly in the undeflected position.

FIG. 8 is an enlarged plan view of the lower bucket assembly of the fourth embodiment as shown in FIG. 7 taken along auxiliary line 8-8.

FIG. 9 is a sectional view of the lower bucket assembly of the fourth embodiment as shown generally in FIG. 8, taken along section line 9-9, showing the assembly in the undeflected position.

FIG. 10A is a sectional view of the lower bucket assembly of the fourth embodiment as shown in FIG. 8, taken along section line 10-10, showing the nipple and détente mechanism when the assembly is in the undeflected position.

FIG. 10B is a sectional view of the lower bucket assembly of the fourth embodiment as shown in FIG. 8, taken along section line 10-10, showing the nipple and détente mechanism when the assembly is in the deflected position.

### DETAILED DESCRIPTION

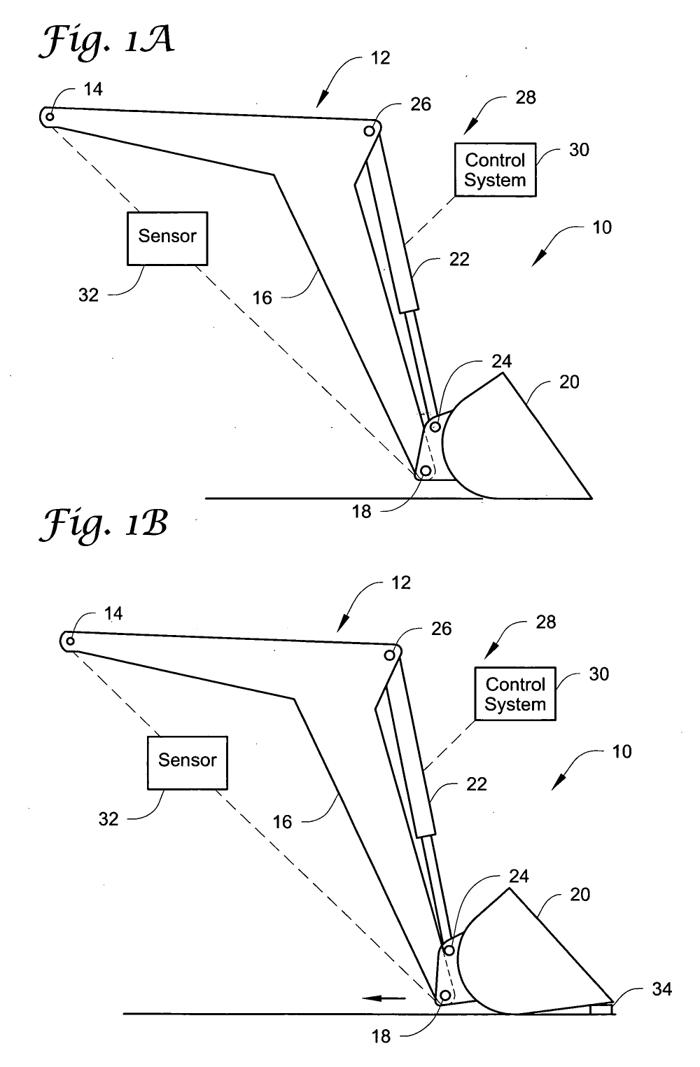

Referring to the drawings, wherein like reference numerals designate identical or corresponding parts throughout the several views, and more particularly to FIGS. 1A and 1B, front end loader apparatus in accordance with the present invention is designated generally by the numeral 10. Designations such as front, back, top, bottom, right side and left side are to be referenced to the vehicle, particularly from the perspective of the vehicle driver. Apparatus 10 includes a frame assembly 12 attached at first pivot points 14 to a vehicle (not shown). Frame assembly 12 includes a pair of downwardly projecting legs 16 which are pivotally attached at second pivot points 18 to bucket 20. Hydraulic cylinders 22 are pivotally attached at third pivot points 24 to bucket 20 and also to frame assembly 12 near the top of downwardly projecting legs 16 at fourth pivot points 26. In the first embodiment, the hydraulic cylinders 22 are part of a mechanism 28 controlled by control system 30, which in conjunction with sensor 32, causes the bucket 20 to tip back upon striking an immovable object 34 as shown in FIG. 1(B). Sensor 32 senses a change in distance between first and second pivot points 14 and 18 or, alternatively, a change in velocity of bucket 20 or an impact deceleration of bucket 20. That is, when bucket 20 has met immovable object 34, sensor 32 sends a signal to control system 30 which determines if a threshold value of the parameter measured has been reached. If the threshold value has been met, control system 30 actuates a contraction of hydraulic cylinders 22 so that bucket 20 tips appropriately and rides up and over the immovable object 34.

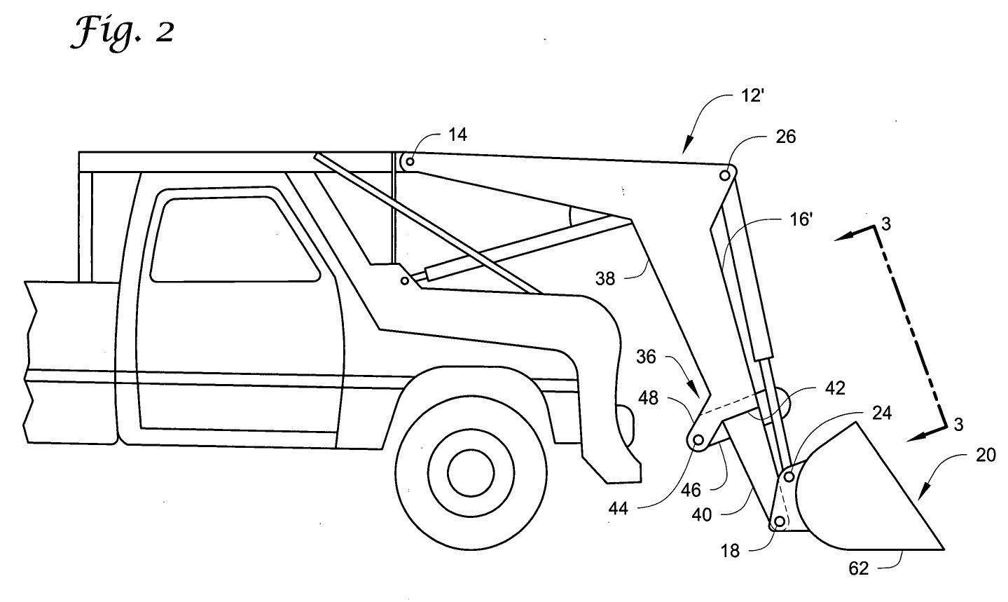

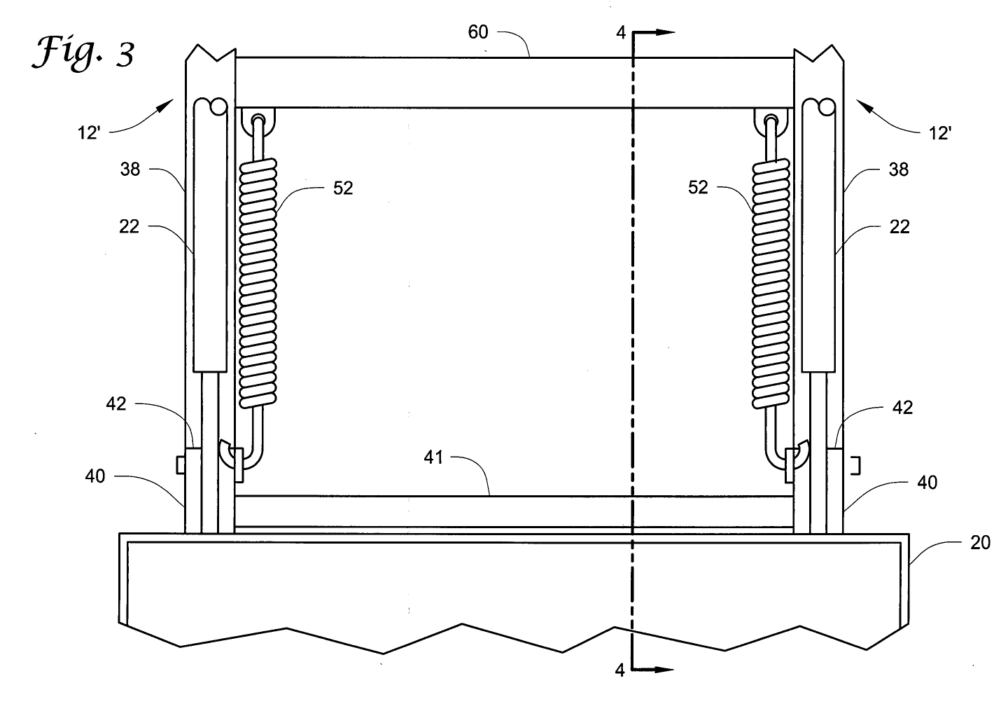

In a second embodiment, the preferred embodiment, as shown in FIGS. 2-5(B), there are two downwardly projecting legs 16′ which have hinged joints 36 which allow bucket 20 to tip relative to frame assembly 12′. Each downwardly projecting leg 16′ has upper and lower portions 38, 40 separated at a break location 42. The two upper portions 38 are rigidly connected by a first cross member 60 as shown in FIG. 3. The two lower portions 40 are rigidly connected by a second cross member 41. The upper portions 38 and lower portions 40 of each of the downwardly projecting legs 16′ are rotatably fastened together at a pivot point 44. Pivot points 44 have axes lying parallel and located rearwardly of the axes of hinged joints 24 and rearward of break locations 42. A lever arm 46 is fixedly attached to the lower portion 40 of each of the downwardly projecting legs 16′. Alternatively, lever arm 46 could be a unitary part of the lower portion 40 of the downwardly projecting leg 16′. A mating leg 48 extends rearwardly from each of the upper portions 38 of downwardly projecting legs 16′ so that the rearward end of lever arm 46 and mating leg 48 are pivotally attached together at a fifth pivot point 44. The lower portions 40 of the downwardly projecting legs 16′ are attached to bucket 20 at second pivot points 18.

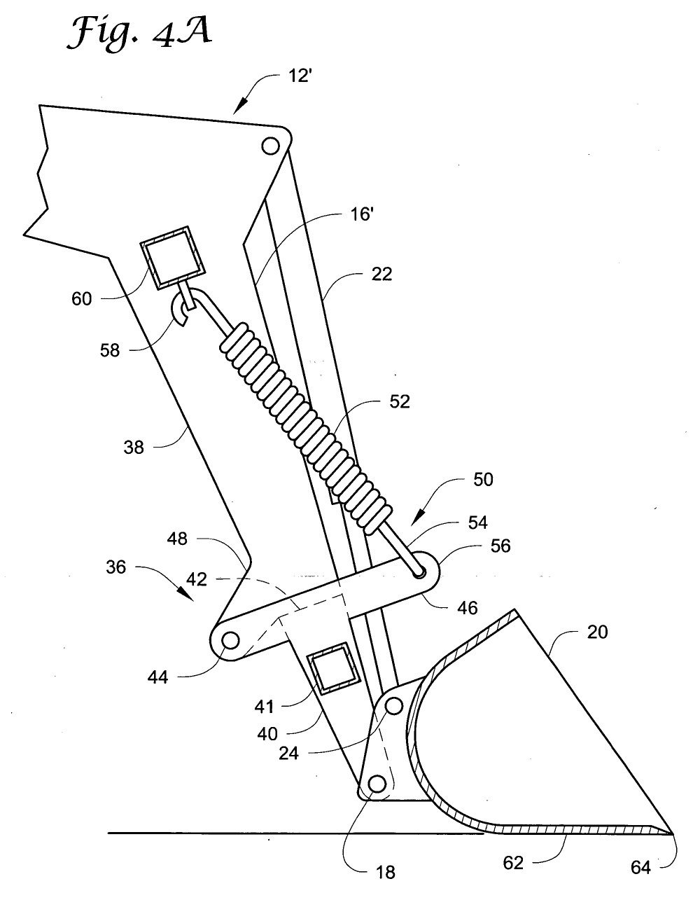

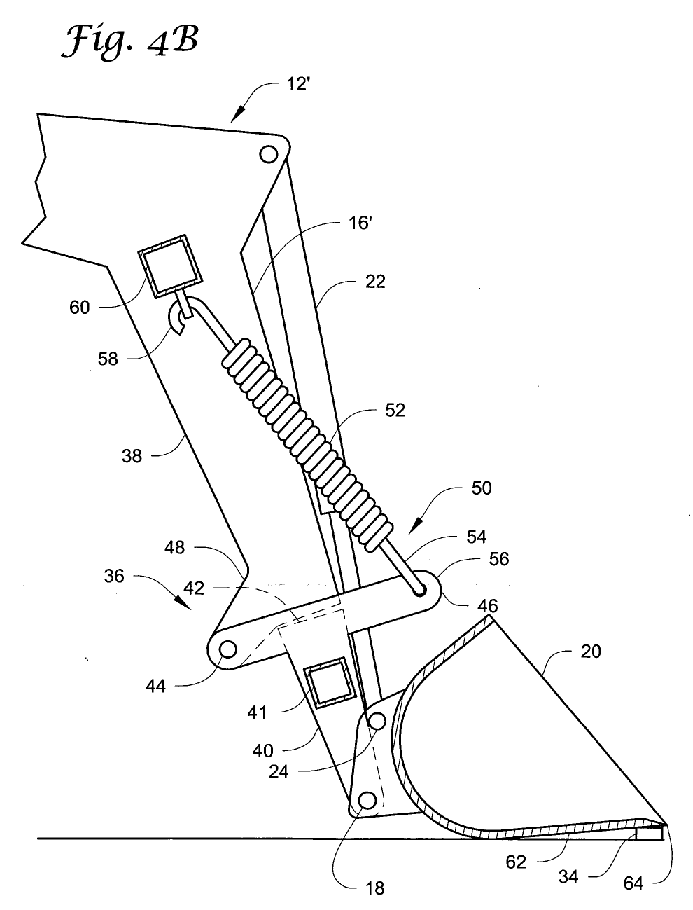

Working in conjunction with hinged joints 36 are hinged joint closing devices 50. With respect to FIGS. 4A and 4B, a hinged joint closing device 50 includes a coil spring 52. One end 54 of the spring 52 is attached to a forwardly extending portion 56 of lever arm 46. The other end 58 of the spring 52 is attached to the first cross member 60 which rigidly connects the upper portions 38 of the downwardly projecting legs 16′. As shown in FIG. 3, there are similar hinged joint closing devices 50 associated with each of the downwardly projecting legs 16′.

In use, apparatus 10 is positioned so that the bottom 62 of bucket 20 is flat on the ground so that the front edge 64 scrapes snow and ice appropriately along the ground. When front edge 64 strikes an immovable object 34 as shown in FIG. 4B, the lower portions 40 of the downwardly projecting legs 16′ pivot backward about fifth pivot points 44. As the lower portion of the downwardly projecting legs 40 pivot backward the bucket 20 pivots about the third pivot points 24 and second pivot points 18 thereby allowing the front edge 64 of the bucket 20 to lift up and over the immovable object 34. Hydraulic cylinder 22 maintains a constant length during these operations. The impact force of the immovable object 34 is counteracted by the hinged joint closing device 50, or more particularly, springs 52. When the impact force of the immovable object 34 overcomes the counteracting spring force, which is determined by the spring constant, as well as the length of the lever arm 46 relative to fifth pivot points 44, the front edge 64 of the bucket 20 will lift up and over the immovable object 34 as shown in FIG. 4B. Once the immovable object 34 has been cleared, the springs 52 will pivot the lower portion 40 of the downwardly projecting legs 16′ about the fifth pivot points 44 so that the upper portions 38 and the lower portions 40 lie directly adjacent one another in the area of break locations 42, thereby resetting the hinged joint closing device 50.

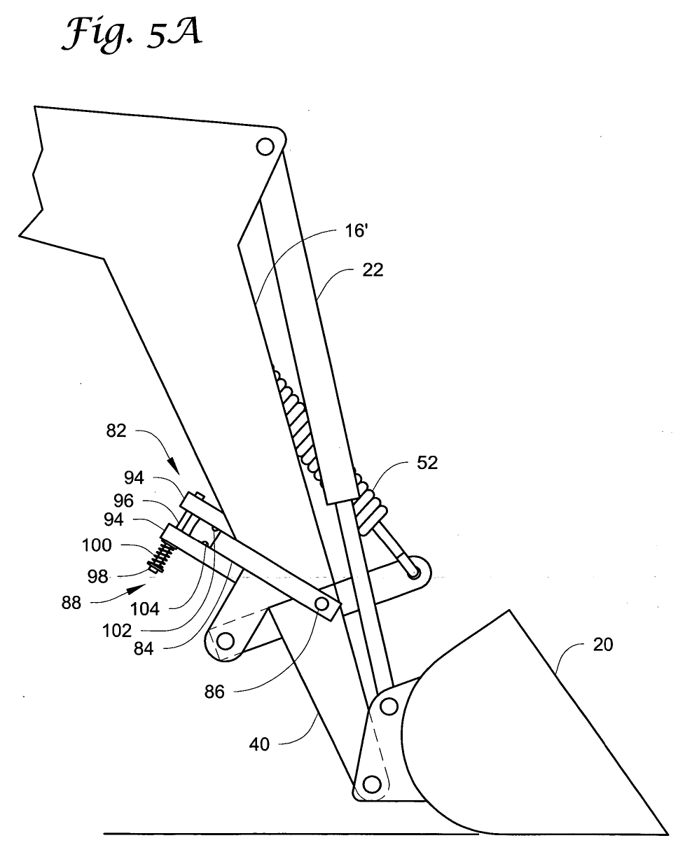

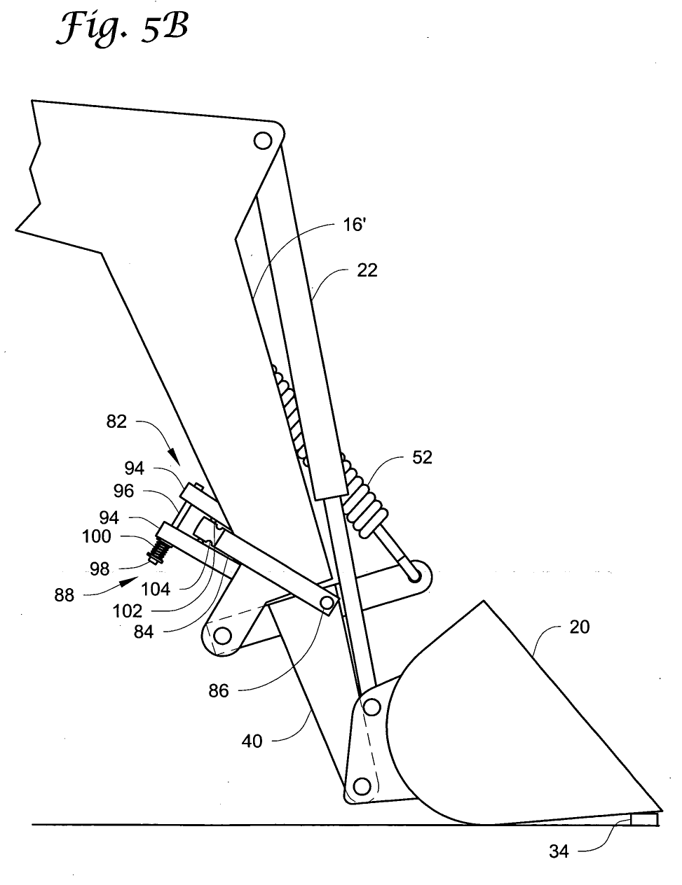

In a further embodiment of apparatus 10 as shown in FIGS. 5A and 5B, a sensor in the form of a mechanical nipple/détente assembly 82 is disclosed. Nipple/détente assembly 82 includes a détente member 84 pivotally attached to both the right and left sides of the lower portion 40 of each downwardly projecting leg 16′at pivot point 86. The detent member 84 additionally provides a stop which prevents the over-rotation of the lower portion 40 of the downwardly projecting leg 16′. A nipple sub-assembly 88 is pivotally attached to the inside of the upper portion 38 of each downwardly projecting leg 16′. Nipple sub-assembly 88 includes a pair of plates 94, on either side of détente member 84, held together with a bolt 96 and nut 98. A coil spring 100 is provided on bolt 96 between nut 98 and one of plates 94. The combination of nut and bolt 98, 96 and spring 100 provides a force adjustment for nipple/détente assembly 82. That is, if nut 98 is tightened against spring 100, it takes more force to separate plates 94 and allow détente member to pull away and further allow hinged joints 36 to open. Protuberance nipples 102 are provided on each of the plates 94, while indention détentes 104 are located to receive nipples 102 when hinged joints 36 are closed. It is preferred that nipple/détente assembly 82 be a part of embodiments 2, 3 and 4.

In use, when an immovable object 34 is struck, if a force is generated above the preset threshold to which spring 100 is adjusted, détente member 84 overcomes the force of the compression spring 100 thereby releasing détente member 84 which allows lower portion 40 to rotate so that the hinge joints 36 open as depicted in FIG. 5B. Once the hinged joints 36 close, nipple/détente assembly 82 resets as in FIG. 5A.

The use of nipple/détente assembly 82 is readily tailored to snowplowing conditions, and may even provide a mechanism for locking out the bucket tilting function during activities such as excavating soil and the like for the front-end loader vehicle.

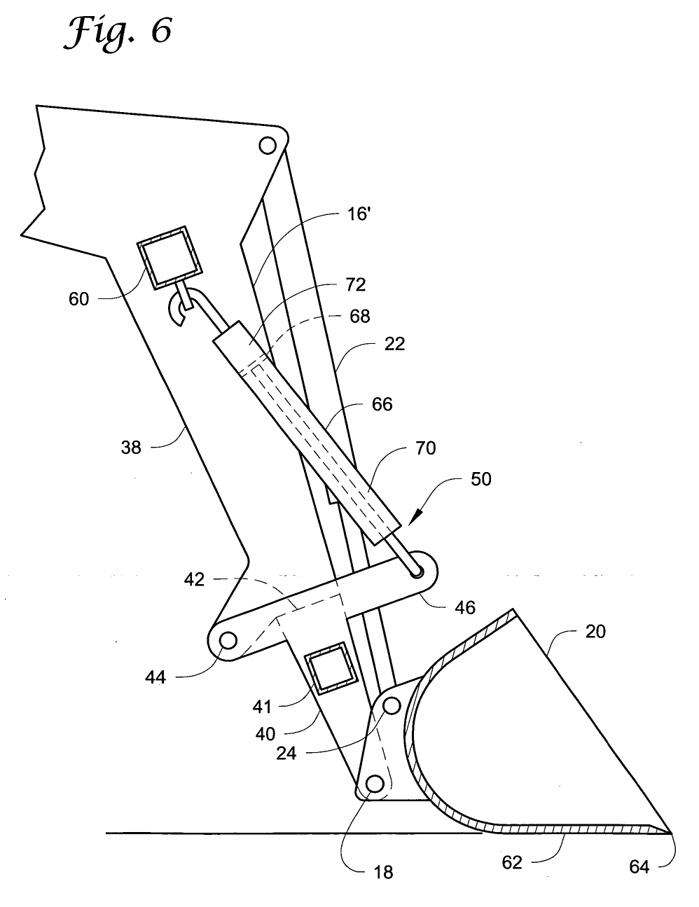

In a third embodiment as shown in FIG. 6, springs 52 of the second embodiment are replaced by fluid-filled (pneumatic or hydraulic) cylinders 66. The rest of the apparatus is as disclosed with respect to the second embodiment. As shown in broken lines, a fluid-filled cylinder 66 includes a piston 68 having first and second chambers 70, 72 on either side of piston 68. When bottom 62 of bucket 20 is sliding along the ground at a level orientation, the first chambers 70 are maintained at a greater pressure than the pressure in the second chambers 72 such that the fluid-filled cylinders 66 provide a biasing force to the end of the lever arms 46.

When front edge 64 strikes an immovable object 34, as similarly shown in FIG. 5B, the lower portions 40 of the downwardly projecting legs 16′ pivot backward about fifth pivot points 44. As the lower portion of the downwardly projecting legs 40 pivot backward, the bucket 20 pivots about the third pivot points 24 and second pivot points 18 thereby allowing the front edge 64 of the bucket 20 to lift up and over the immovable object 34. Hydraulic cylinder 22 maintains a constant length during these operations. The impact force of the immovable object 34 is counteracted by the hinged joint closing device 50, or more particularly fluid-filled cylinders 66. When the impact force of the immovable object 34 overcomes the counteracting force provided by the fluid-filled cylinders, the front edge 64 of the bucket 20 will lift up and over the immovable object 34. Once the immovable object 34 has been cleared, the fluid-filled cylinders 66 will pivot the lower portion 40 of the downwardly projecting legs 16′ about the fifth pivot points 44 so that the upper portions 38 and the lower portions 40 lie directly adjacent to one another in the area of break locations 42, thereby resetting the hinged joint closing device 50.

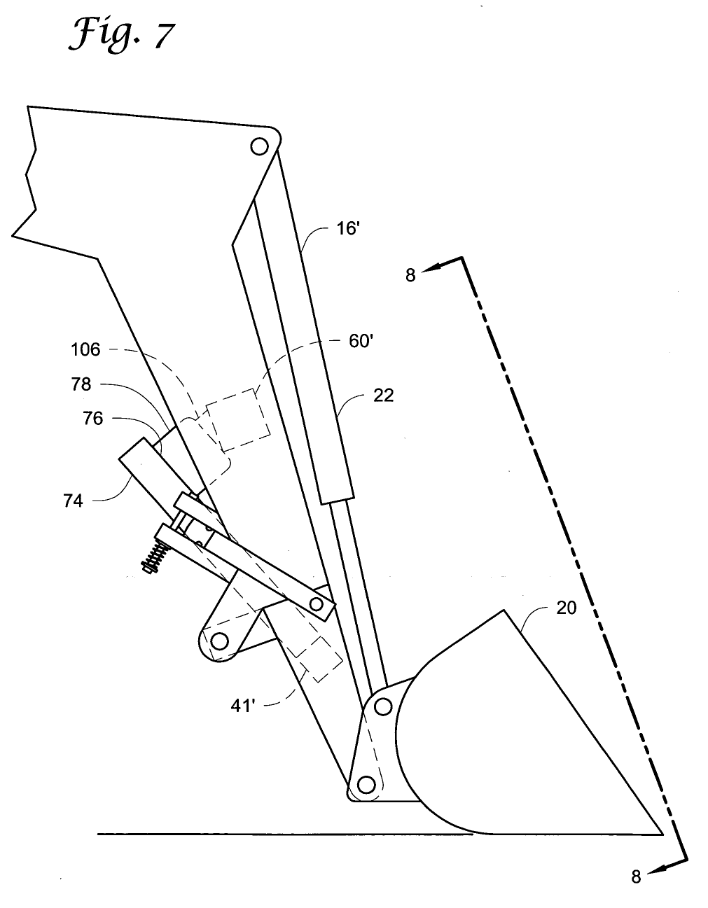

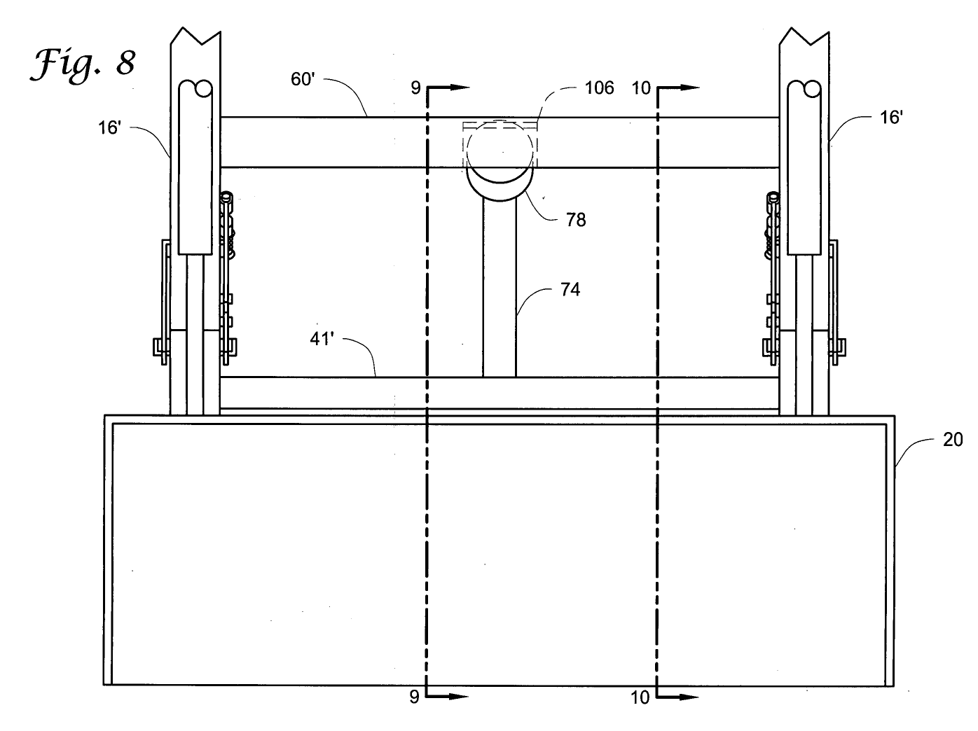

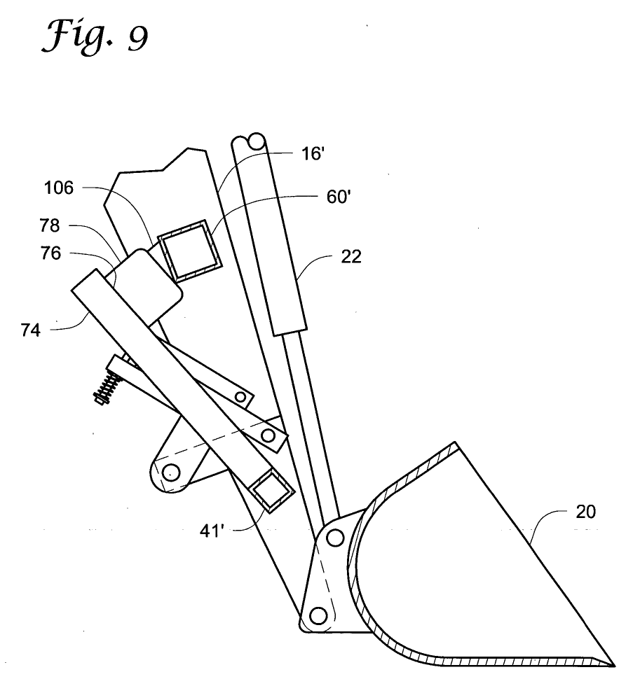

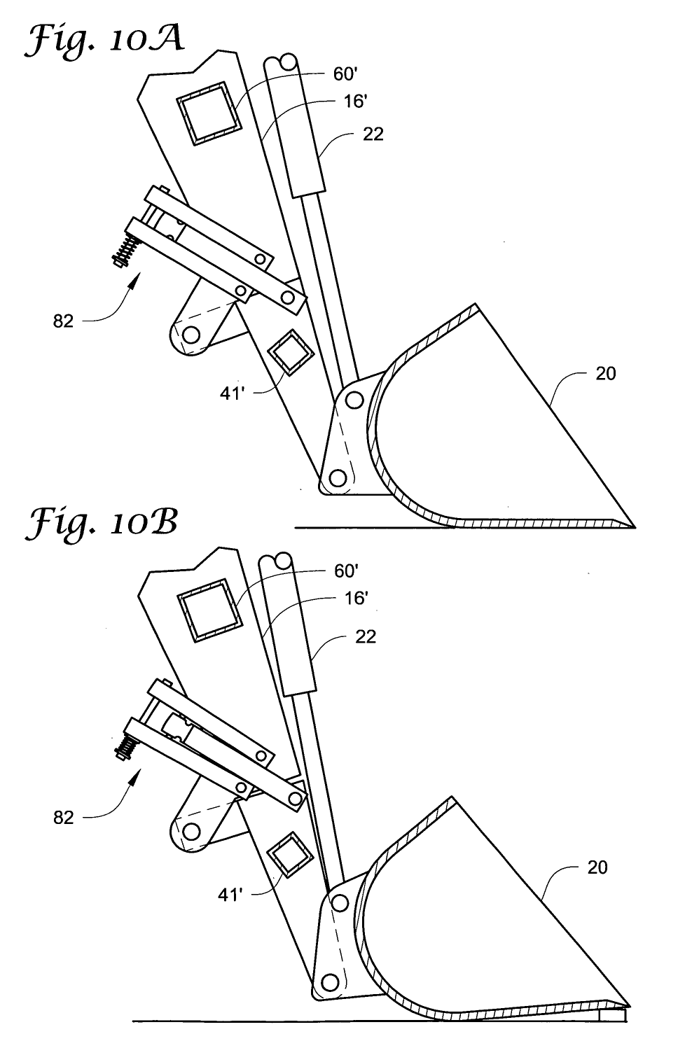

In a fourth embodiment as shown in FIGS. 7-10B, a different type of fluid-filled or elastomeric device is used. A lever arm 74 is solidly attached to the second cross member 41′ near its midpoint. The top end portion 76 of lever arm 74 includes a bumper member 78 comprising a volume-constrained fluid-filled bag, or an elastomeric member, which presses against a bumper coupler member 106 which is attached to a first cross member 60′ near its midpoint. When bucket 20 strikes an immovable object 34 causing hinged joint 36 to open, lever arm 74 presses the bumper member 78 against the bumper coupler member 106 thereby causing it to deform. This deformation stores energy in the bumper member 78 as either increased fluid pressure in the case of the volume-constrained bag, or as stored elastic energy in the case of an elastomeric member. The deformation of the bumper member 78 opposes the opening of hinged joints 36 and urges them closed. As this occurs, bucket 20 rides over immovable object 34 as discussed earlier.

Thus, preferred embodiments of front-end loader apparatus, in accordance with the present invention have been described in detail. It is understood, however, that equivalents to the disclosed invention are possible. Therefore, it is further understood that changes made, especially in matter of shape, size and arrangement to the full extent extended by the general meaning of the terms in which the appended claims are expressed, are within the principle of the invention.

What is claimed is:

1. Front end loader apparatus for attachment to a vehicle, comprising:
a bucket;
a frame assembly attachable at one side to said vehicle to form a first pivot axis and attached at another side to said bucket to form a second pivot axis, said first and second pivot axes being separated by a distance;
a sensor sensing when the distance between said first and second pivot axes contracts a predetermined amount; and
a mechanism providing for said bucket to pivot about said second axis so as to tilt when the predetermined amount of contraction is sensed by said sensor.

2. Front end loader apparatus for attachment to a vehicle, comprising:
a bucket:
a frame assembly attachable at one side to said vehicle to form a first pivot axis and at another side having a pair of downwardly projecting legs pivotally attached to said bucket to form a second pivot axis;
a member located forwardly of said downwardly projecting legs and extending between said frame assembly and said bucket, said member being pivotally attached to said bucket to form a third pivot axis;
a sensor sensing when said bucket strikes an immovable object;
one of said pair of downwardly projecting legs and said member including a mechanism providing for said bucket to pivot about said second and third pivot axes so as to tilt and ride over said immovable object when said sensor senses said immovable object.

3. The front end loader apparatus in accordance with claim 2, wherein said member includes an hydraulic cylinder attached between said frame assembly and said bucket and a control system for said hydraulic cylinder, wherein when said sensor senses the immovable object, said control system causes said hydraulic cylinder to contract which causes said bucket to tilt and ride over the immovable object and when said bucket has safely bypassed the immovable object, said control system causes said hydraulic cylinder to extend which causes said bucket to return to a scraping orientation.

4. The front end loader apparatus in accordance with claim 2, wherein said sensor senses a change in distance between said first and second pivot axes.

5. The front end loader apparatus in accordance with claim 2, wherein said sensor senses one of a change in velocity of said bucket and an impact force to said bucket.

6. The front end loader apparatus in accordance with claim 2, wherein said mechanism includes hinged joints in each of said projecting legs and a hinged joint closing device urging said hinged joints closed.

7. The front end loader apparatus in accordance with claim 6, wherein said hinged joint closing device includes a fluid-filled device.

8. The front end loader apparatus in accordance with claim 6, wherein said hinged joint closing device includes a spring.

9. The front end loader apparatus in accordance with claim 6, wherein said hinged joint closing device includes an elastomeric member.

10. The front end loader apparatus in accordance with claim 6, wherein said projecting legs of said frame assembly have upper portions and lower portions separated at break locations, said upper portions and said lower portions being rotatably fastened together at axes to form said hinged joints, said axes being located rearward of said break locations in said legs, said frame assembly further having a lever arm extending forwardly of said axes and attached to a least one of said lower portions wherein the closing force from said hinged joint closing device is applied to said lever arm.

11. The front end loader apparatus in accordance with claim 2, wherein said sensor includes a nipple and détente assembly 12. Front end loader apparatus for attachment to a vehicle, comprising:
a bucket;
a frame assembly attachable at one side to said vehicle to form a first pivot axis and at another side including a pair of downwardly projecting legs pivotally attached to said bucket to form a second pivot axis;
a member located forwardly of said downwardly projecting legs and extending between said frame assembly and said bucket, said member being pivotally attached to said bucket to form a third pivot axis;
means for sensing when said bucket strikes an immovable object;
one of said pair of downwardly projecting legs and said member including means for pivoting said bucket about said second and third pivot axes so as to tilt and ride over said immovable object when said sensing means senses said immovable object.
